(19) United States
(12) Patent Application Publication
(10) Pub. No.: US 2009/0257420 A1
(43) Pub. Date: Oct. 15, 2009

(54) Process Control System With Enhanced Communication Throughput Using Frequency Agility

(75) Inventors: Vinayak S. Kore, Bangalore (IN); Arun V. Mahasenan, Bangalore (IN); Gourango Biswas, Bangalore (IN); SrinivasaRao Katuri, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NE (US)

(21) Appl. No.: 12/100,428

(22) Filed: Apr. 10, 2008

(51) Int. Cl. H04J 3/00

(52) U.S. Cl. 370/345

(57) ABSTRACT

A process control system having wireless nodes (field devices, routers, wireless gateways, etc.) communicating with enhanced throughput using frequency hopping. The frequency channel using which each node transmits is determined by frequency agility/frequency hopping technique. Multiple nodes then transmit the packets in their respective channels, but in overlapping duration. In one embodiment such a technique is employed in combination with TDMA, with the boundaries of time slots being ‘global’ (same for all the nodes in the network) and thus the overlapping duration equals the duration of the time slot. In an alternative embodiment employed in combination of SDMA, each node transmits in a (substantially) non-overlapping corresponding beam area, but without reference to global boundaries. In yet another alternative embodiment, a combination of SDMA, TDMA and overlapping duration is used.

### TECHNICAL FIELD

The present disclosure relates generally to process control systems, and more specifically to providing enhanced communication throughput using frequency agile wireless networks in such process control systems.

### RELATED ART

A process control system generally contains several field devices, control system(s), management stations, etc. In general, the control system implements a desired control process by controlling the operation of various field devices. Examples of field devices include valves, positioners and switches, which are controlled to implement the desired control process. The management stations may be used by operators/administrators to configure, manage and control the control systems and field devices as is also well known in the relevant arts. Examples of process control systems include, without limitation, systems to control corresponding processes in oil refineries, pharmaceutical industry, petrochemical plants, energy production plants etc.

There is a general need to provide connectivity between various devices/systems/stations, etc., (in general, nodes) noted above, of a process control system. The connectivity can be based on wireless or wired medium.

As is well known in the relevant arts, frequency agility generally refers to a technique according to which a frequency of a transmitter is changed between corresponding transmission intervals. As also is well known in the relevant arts, frequency hopping is generally a specific type of frequency agility in which the frequency of a transmitter's carrier signal used for transmission is selected to be different in different transmission intervals, with the corresponding frequencies often being predetermined, for example, according to a pseudorandom sequence known to both transmitter and receiver. Frequency agility/frequency hopping (FH) is often used for wireless communication among nodes of a process control network.

It is often desirable that process control networks be implemented with enhanced communication throughput when using frequency hopping.

### BRIEF DESCRIPTION OF THE DRAWINGS

Example embodiments will be described with reference to the accompanying drawings, which are described below briefly.

FIG. 1 is a block diagram of an example process control system in which several aspects of the present invention can be implemented.

FIG. 2 is a diagram illustrating the manner in which nodes communicate using frequency hopping according a to a prior technique.

FIG. 3 is a flowchart illustrating the manner in which enhanced communication throughput is obtained using frequency hopping in process control systems in an embodiment of the present invention.

FIG. 4 is a diagram illustrating the manner in which nodes communicate using frequency hopping in an embodiment of the present invention.

FIG. 5 is a diagram illustrating a portion of a process control system in an alternative embodiment of the present invention, in which space division multiple access (SDMA) technique is used in combination with frequency hopping technique, according to another aspect of the present invention.

FIG. 6 is a diagram illustrating packet transmission/reception with respect to time in an embodiment of the present invention using SDMA.

FIG. 7 is a block diagram of a transceiver used in an embodiment of the present invention.

FIG. 8A is a block diagram of a receive front end in an embodiment.

FIG. 8B is a block diagram of a receive IF processing unit in an embodiment.

FIG. 9 is a block diagram of a receive baseband processing unit in an embodiment.

FIG. 10 is a block diagram of a transmit baseband processing unit and transmit IF processing unit.

FIG. 11 is a block diagram of a transmit RF front end in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. OVERVIEW

A process control system having nodes (field devices, routers, wireless gateways, etc.) wirelessly communicating with enhanced network throughput using frequency agility technique. The frequency channel using which each node transmits is determined by frequency agility technique. Multiple nodes then transmit the packets in their respective channels, but in overlapping duration (i.e., simultaneous multiple transmissions). As multiple nodes transmit at the same time, the throughput performance may be enhanced.

In one embodiment employing TDMA (time division multiple access) technique in addition, the boundaries of time slots are ‘global’ (same for all the nodes in the network). That is, the boundaries of the interval in which transmission can start and end is the same for all nodes. In such a case, the overlapping duration equals the duration of the time slot. Such an approach may be particularly suited in dense networks with nodes requiring similar bandwidth (nodes whose transmission requirements are fairly predictable, as against being bursty).

In an alternative embodiment employing SDMA (space division multiple access) along with simultaneous multiple transmissions, each node transmits in a (substantially) non-overlapping corresponding beam area, but without reference to global boundaries. Thus, the boundaries of the time durations of the time slots are not fixed in this embodiment. Due to the SDMA feature, noise interference and/or power requirements in each node may be reduced.

In yet another alternative embodiment, a combination of SDMA, TDMA and simultaneous multiple transmissions, is used. In this embodiment, the boundaries of the transmissions are aligned as in the TDMA embodiment noted above. Each node transmits in a corresponding non-overlapping beam area as in SDMA embodiment noted above.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. EXAMPLE PROCESS CONTROL SYSTEM

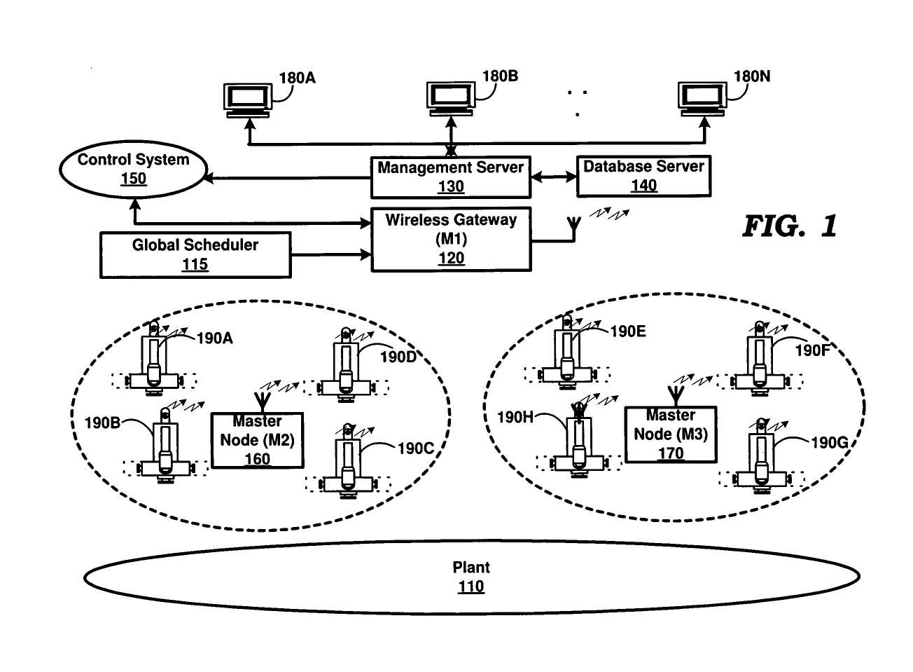

FIG. 1 is a block diagram of an example process control system (controlling the equipment, not shown, in plant 110) in which several aspects of the present invention may be implemented. The process control system is shown containing wireless gateway 120, global scheduler 115, management server 130, database server 140, control system 150, operator terminals 180A through 180N, master nodes 160 and 170, and wireless field devices 190A through 190H.

Merely for illustration, only representative numbers/types of components/clusters, etc., are shown in FIG. 1. However, typical environments contain many more components. For example, some or all of the field devices (as well as other devices/systems) may be connected by wire-based paths as well. Each block is described in detail below.

Plant 110 represents a process control plant whose operation is to be controlled. Plant 110 may contain equipment such as boilers, filters, furnace, cooler, etc., which may be connected to wireless field devices 190A-190H. Though shown separated from the wireless field devices, the equipment and the devices are generally integrated with the equipment in the plant.

Wireless field devices 190A-190H represent field devices (such as temperature sensors, pressure sensors, actuators etc.) used for monitoring/controlling/configuring (in general, to manage) the operation of plant 110, and operate according to control commands received from control system 150 (via master nodes M1 and M2/M3). In an embodiment, wireless field devices 190A-190H provide process values (e.g., temperature, pressure etc of various equipment in plant 110) to control system 150 or accept output values (to control output devices such as actuators in plant 110) from control system 150. The setting or acceptance of output values may cause the desired operation of the corresponding equipment.

Operator terminals 180A-180N provide a suitable user interface using which an operator can manage/monitor the various equipment in plant 110 via wireless field devices 190A-190H. In general, an operator may cause issuance of management and process control configuration commands to plant 110 and wireless field devices 190A-190H using one or more of operator terminals 180A-180N.

Database server 140 may store various control strategies to control the operation of plant 110 according to a desired objective, which can be loaded into control system 150 after any necessary changes. Database server 140 may include information on the parameters to be configured on wireless field devices 190A-190H.

Management server 130 receives various interface commands (either from operator terminals 180A-180N or from an operator directly from keyboards, not shown) and generates corresponding management commands for controlling the operation of plant 110. Management server 130 provides appropriate data for incorporation into various screens displayed at operator terminals 180A-180N. The data may be formed from local data (stored with the management server), from database server 140, from plant 110 received via wireless field devices 190A-190H. In addition, management server 130 may retrieve various control strategies from database server 140 and load the retrieved strategies into control system 150 upon corresponding commands from operator terminals 180A-180N.

Control system 150 generates control commands according to pre-loaded control strategies to control the operation of wireless field devices 190A-190H. The control strategies generally have predefined computational sequences on variables representing states of one or more processes in plant 110. The execution of a control strategy entails performing such computational sequences using (input) values for input variables as well as various other preset parameters for respective variables. Though the control strategies are described as being implemented centrally in control system 150 for ease of understanding, it should be appreciated that some of the strategies can be implemented in a more distributed manner (e.g., in field devices themselves).

At least due to the various communications described above, it may be necessary to provide connectivity between the various systems/devices (in general, nodes) noted above. Several aspects of the present invention provide for such communication based on frequency hopping as described below in further detail.

Master node 160 and wireless field devices 190A-190D are shown as forming a “cluster”, with wireless field devices 190A-190D operating as slave nodes and master node 160 operating as a master node. Each of the end nodes of communication are viewed as slave nodes, while the nodes that aggregate and route packets are viewed as master nodes. The end devices may be battery operated and resource constrained. The master nodes may be line powered and resource rich. The master nodes may perform various other functions such as dissemination of common clock reference, allocation of transmission slots to the end nodes, etc.

Similarly, master node 170 and wireless field devices 190E-190H are shown as forming another “cluster”, with wireless field devices 190E-190H operating as slave nodes and master node 170 operating as a master node.

Wireless gateway 120 may, in addition, operate as a master node (M1), and be associated with a different cluster containing other wireless field devices not shown. Wireless gateway 120 is also referred to as master node M1 below. Further, although denoted distinctly as master nodes and wireless field devices, each of the devices is also referred to below just as a “node”.

Global scheduler 115 allocates time slots and frequency hopping sequences to all the nodes, and contains global topology information (specifying which nodes are currently present and operational in the network, how the network is connected). Global scheduler 115 may receive periodic updates about the topology information (e.g., addition/removal of nodes, connectivity) from the nodes (master as well as wireless field device). Global scheduler 115 can reuse (reallocate) an already allotted frequency channel to other nodes outside the interference range of the nodes which are already allocated the channel.

Wireless gateway 120 (master node M1) receives communication packets (e.g., control commands/data etc.) from control system 150 (on a wire-based path), and transmits the communication packets over a wireless medium using frequency hopping technology to master node 160 (M2) and/or master node 170 (M3). The packets may be intended for wireless field devices 190A-190H. Wireless gateway 120 receives packets (containing, for example, process values such as temperature, pressure, etc., or response to previous commands sent) from wireless field devices 190A-190H over the wireless medium via master nodes M2 and M3, and provides them to control system 150.

Master node 160 forwards communication packets received from M1 to the corresponding one of wireless field devices 190A-190D, based for example, on a destination address in the packets. Master node 160 forwards packets received from wireless field devices 190A-190D to M1 (wireless gateway 120). Similarly, master node 170 forwards communication packets received from M1 to the corresponding one of wireless field devices 190E-190H, based for example, on a destination address in the packets. Master node 160 forwards packets received from wireless field devices 190E-190H to M1.

Thus, master nodes 160 and 170 may also be viewed as “router” nodes, routing packets between a source node and a destination node. Wireless gateway 120, master nodes M2 and M3 and wireless field devices 190A-190H may be implemented in a known way. While the control system and wireless gateway are shown as being implemented as physically separate units, alternative embodiments can be implemented to integrate the two into a single physical unit.

As noted above, master nodes M1, M2 and M3 and wireless field devices 190A-190H may communicate using frequency hopping. An aspect of the present invention enables enhanced throughput performance to be obtained using frequency hopping. The features of the invention will be clearer in comparison to a prior technique, and the manner in which such communication is performed according to such prior technique is described next.

### 3. PRIOR FREQUENCY HOPPING COMMUNICATION TECHNIQUE

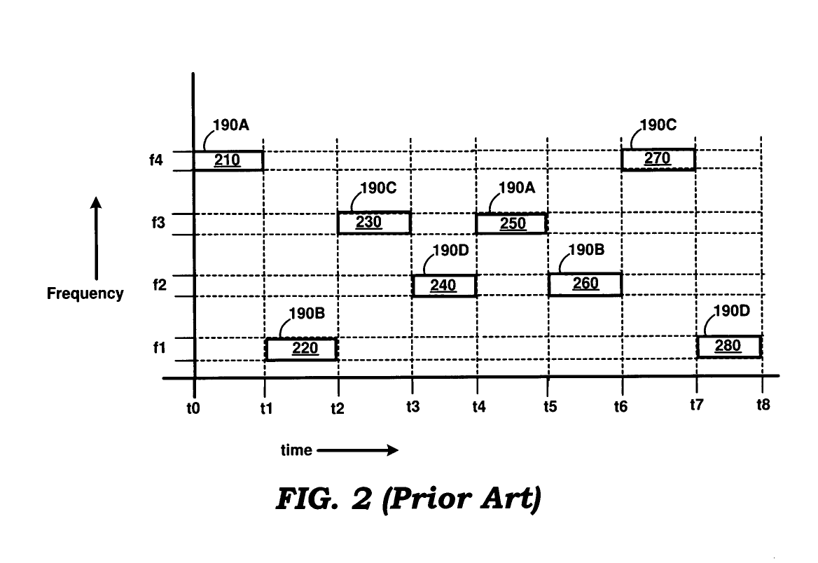

FIG. 2 is a diagram illustrating the manner in which nodes communicate using frequency hopping according a to a prior technique. For simplicity the following description describes communication among master node 160 and wireless field devices 190A-190D. Merely for conciseness, frequency hopping communication between master node 160 and wireless field devices 190A-190D is shown as using only four frequency channels f1-f4.

In general, each frequency channel is defined by a narrow band of frequencies in which data is transferred in a corresponding time duration. Further, while the example embodiments are described with respect to frequency hopping (FH), it must be understood that alternative embodiments can be implemented using other frequency agility techniques without departing from the scope and spirit of several aspects of the present invention.

Typically, many more (for example, 32) frequency channels may be used, and packets between master node 160 and corresponding wireless field devices may be transferred by using multiple frequency channels over time according to corresponding predetermined frequency hopping patterns.

Master node 160 sends (or receives) communication packet 210 in a frequency channel f4 to (or from) wireless field device 190A in a time interval (corresponding to time slot) t0-t1.

Similarly, master node 160 sends (or receives) communication packets 220, 230 and 240 in respectively non-overlapping frequency channels f1, f3 and f2 to (or from) respective wireless field devices 190B, 190C and 190D in (the time interval of) corresponding time slots t1-t2, t2-t3 and t3-t4.

Master node 160 sends (receives) a next (second) packet 250 to (from) wireless field device 190A in frequency channel f3 in time slot t4-t5 (or specifically, the corresponding time duration). Similarly, master node 160 sends (receives) subsequent packets 260, 270, and 280 to (from) respective wireless field devices 190B, 190C and 190D in frequency channels f2, f4 and f1 in corresponding time slots t5-t6, t6-t7 and t7-t8. Subsequent packets may be transferred in a correspondingly similar manner.

Thus, master node 160 and wireless field devices 190A-190D communicate using frequency hopping technique, with communication between master node 160 and a wireless field device being done using different frequency channels during different communication intervals.

It may be observed that in a time slot, communication takes place between master node and only any one of the wireless field devices. For example, during interval t0-t2 packet transfer occurs only between master node 160 and wireless field device 190A. In several operation scenarios, such an approach may provide less than a desired overall communication throughput (e.g., as measurable by a total number of packets transferred in unit time among all nodes).

Several aspects of the present invention enable enhanced communication throughput in a process control network using frequency hopping, as described next.

### 4. ENHANCED COMMUNICATION THROUGHPUT USING FREQUENCY HOPPING

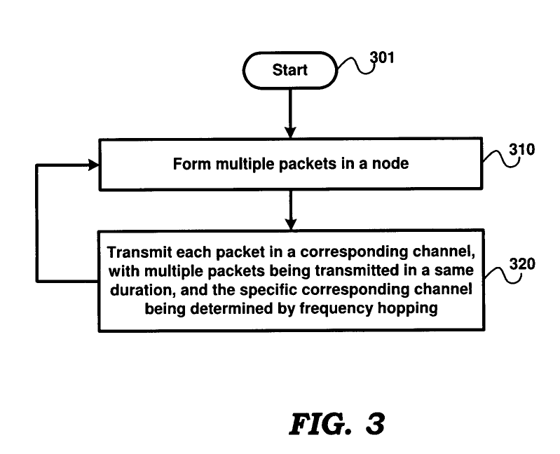

FIG. 3 is a flowchart illustrating the manner in which enhanced communication throughput is obtained using frequency hopping in process control systems in an embodiment of the present invention. The flowchart is described with respect to FIG. 1 merely for illustration. However, various features described herein can be implemented in other environments, as will be apparent to one skilled in the relevant arts by reading the disclosure provided herein. The flowchart starts in step 301 in which control is transferred to step 310.

In step 310, multiple packets are formed in a node. The content (e.g., the header information and the payload) packet may be formed consistent with corresponding protocols and the specific data sought to be transferred. Control then passes to step 320.

In step 320, each packet (formed in each corresponding node) is transmitted in a corresponding channel, with multiple packets being transmitted in a same duration, and the specific corresponding channel being determined by frequency hopping (or agility in general). As described in sections below with examples, such time duration may or may not be aligned with time slots. The frequency hopping pattern (i.e., the sequence of channels used in transmitting the corresponding sequence of packets) used by the node may be selected such that no two nodes transmit in a same channel simultaneously (or overlapping durations).

Control then passes back to step 310, and a corresponding packet is formed in each node, and the steps above may be repeated. Due to the transmission of multiple packets in a time duration, enhanced throughput performance may be obtained. The features noted in the flowchart are further illustrated next with some examples.

### 5. EXAMPLE

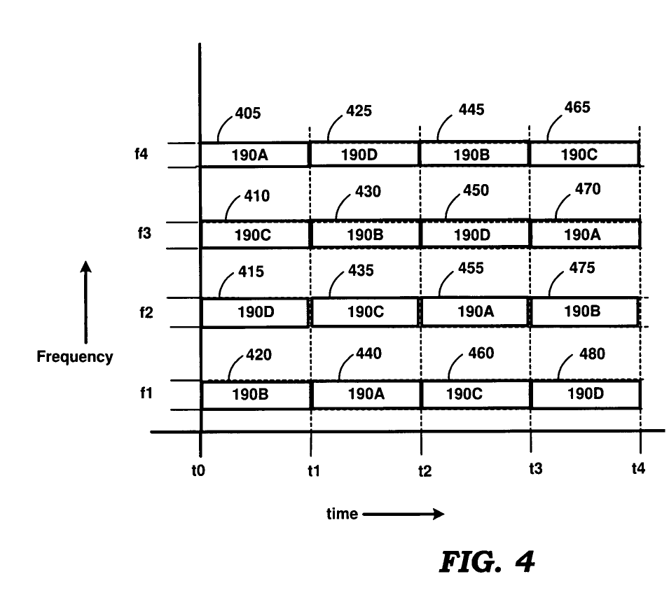

FIG. 4 is a diagram illustrating the manner in which nodes communicate using frequency hopping in an embodiment of the present invention. Again, the description is provided with respect to communication among master node 160 and wireless field devices 190A-190D merely as an illustration. Each packet is identified by a number and the content of the packet indicates the specific field device to/from which the packet is being transmitted.

Further, frequency hopping communication between master node 160 and wireless field devices 190A-190D is shown as using only four frequency bands (channels) f1-f4. Typically, many more (for example, 32) frequency channels may be used, and communication packets between master node 160 and corresponding wireless field devices 190A-190D may be transferred by using multiple frequency channels simultaneously according to corresponding predetermined frequency hopping patterns.

As shown in FIG. 4, in time slot t0-t1 (or the time slot in interval t0-t1), master node 160 sends (or receives) packets 405, 410, 415 and 420 respectively in frequency channels f4, f3, f2 and f1 to (or from) respective wireless field devices 190A, 190C, 190D and 190B. It is noted that the direction of packet transfer can be all from master node 160 to the wireless field devices, all from wireless field devices 190A-190D to master node 160, or some from master node 160 to some of the wireless field devices and others from other wireless field devices to master node 160.

For example, master node 160 may send (transmit) packets 405 and 410 to wireless field devices 190A and 190C respectively, while receiving packets 405 and 410 to wireless field devices 190A and 190C respectively. As another example, all packets transmitted in time slot t0-t1 may be from master node 160 to wireless field devices 190A-190D, or vice versa.

Similarly, in time slot t1-t2, master node 160 sends (or receives) communication packets 425, 430, 435 and 440 respectively in frequency channels f4, f3, f2 and f1 to (or from) respective wireless field devices 190D, 190B, 190C and 190A.

In time slot t2-t3, master node 160 sends (or receives) communication packets 445, 450, 455 and 460 respectively in frequency channels f4, f3, f2 and f1 to (or from) respective wireless field devices 190B, 190D, 190A and 190C.

In time slot t3-t4, master node 160 sends (or receives) communication packets 465, 470, 475 and 480 respectively in frequency channels f4, f3, f2 and f1 to (or from) respective wireless field devices 190C, 190A, 190B and 190D. Subsequent packets may be transferred in a correspondingly similar manner. Master node 170 may communicate with wireless field devices 190E-190H) in a similar manner. Wireless gateway (master node M1) and master nodes M2 (160) and M3 (170) may also communicate with one another in a similar manner.

Thus, master node 160 and wireless field devices 190A-190D communicate using frequency hopping technique, with communication among the nodes (including master node 160 and wireless field devices 190A-190D) being done using different frequency channels during a same duration.

It may be appreciated that each of master node 160 and wireless field devices 190A-190D may require corresponding set-up procedures prior to communicating in the manner described above. In an embodiment, master node 160 may first start a discovery procedure to identify the number of slave nodes (wireless field devices 190A-190D). Master node 160 may then determine the frequency channel to be used when communicating with the respective discovered slave nodes. Further, master node 160 may determine whether it needs to transmit to or receive from the respective slave nodes in corresponding time slots. In addition, master node 160 may also determine the time duration for which communication (transmit or receive) is to be performed with each of the corresponding slave nodes.

Similarly, each of slave nodes 190A-190D may determine the frequency channel to be used when communicating (whether transmitting or receiving) with master 160. Each slave node may also determine whether it needs to transmit to or receive from master node 160 in corresponding time slots. Further, each slave node may also determine the time duration for which communication (transmit or receive) is to be performed with master node 160.

The frequency hopping pattern (i.e., the specific frequency channel in which a node should transmit in a specific time slot) for each node (master/wireless field devices) may be selected and provided in a known way by global scheduler 115 in such a way that no two nodes transmit in a same channel in a same time slot.

Alternatively, the FH pattern and phase may be programmed in the nodes, or provided to the nodes via an additional communication link (not shown) by an operator using any of operator terminals 180A-180N. In general, the spacing (frequency difference) between the frequency channels used for FH is chosen to minimize/avoid interference.

In an embodiment, 2.4 GHz ISM band is used for the frequency hopping communication, with fifty frequency hopping bands/channels. Transmission from one node to another node cycles through each of the fifty channels over corresponding fifty time slots, with the sequence of the channels (frequency hopping pattern) being programmed, as noted above.

In an embodiment, a superframe (a logical unit of time to co-ordinate communication) is ten seconds long, and is divided into multiple time slots. A communication packet (also termed a frame) and a corresponding acknowledgement are transmitted in a single slot using a same channel. Some of the slots may be control slots, used for coordinating inclusion/association of new nodes into the network, as well as other network management activities.

A master node (such as master node 160) may tune its transceiver to predefined control channels, and wait for receiving association requests from end nodes (such as wireless field devices 190A-190D). Such control channels ensure that unsynchronized new nodes will not disturb the communication of the nodes existing in the network.

During an association procedure, end nodes get synchronized to the master node (i.e., local time bases for calculating transmission and reception time slots are aligned). The end node indicates its FH pattern to the master node, and requests communication slots. The master node checks if slots are available and whether the FH sequence is not clashing with any other existing node. If both these conditions are met, the master node sends the slot allocation to the requesting end node.

While checking availability of the slots, the master node considers the possibility of multiple simultaneous (in a same duration) transmissions and/or receptions, as described above. In general, if the transceiver in a master node is implemented to support ‘N’ parallel communications (N being 4 in the example of FIG. 4), the master node can allocate a same time slot to (a maximum of) N end nodes. The master nodes (which operate as router nodes, as noted above) are implemented to have a wide band transceiver which can simultaneously communicate (transmit/receive) in multiple frequency channels.

If slots are available, but if two or more FH sequences clash (i.e. if the FH sequences indicate that two (or more) nodes might use a same channel in a same slot), the master node requests the end node(s) to change either just the phase of the FH sequence or the complete FH sequence, so as to avoid collision.

An end node selects a channel according to the assigned (or programmed) FH sequence and phase while communicating (transmitting or receiving) in its slot. The phase specifies which specific frequency (channel/band) is to be used for a current transmission, and is advanced to a next phase in the FH sequence after every communication. Thus, a node uses a next channel of its FH sequence in every successive communication slot allocated to it.

In an allocated slot, an end node can exchange (either transmit or receive) one communication frame with a master node. Whether an end node wishes to transmit or receive a communication frame in a particular slot is indicated by the end node to the master node during the association process, described above.

Thus, the master node knows FH patterns, phase and direction of communication (Tx or Rx) of all end nodes associated with it. For example, master node 160 stores the FH patterns, phase and direction of communication (Tx or Rx) of all end nodes 190A-190D in a slot allocation table. At the beginning of a slot, the master node may check the slot allocation table, and controls (tunes) its transceiver (transmit and receive radio, described below) to enable the corresponding transmission and/or reception.

Whenever same slot is allocated to multiple end nodes, the master node tunes the transceiver to the corresponding channels that will be used. Depending on direction of communication, the master node configures the transceiver to either receive or transmit in the corresponding channels. The master node then provides corresponding transmit data for transmission to receiver end devices, and stores the data received from transmitter end nodes over the corresponding channels. Acknowledgment may also be sent/received by the nodes.

In general, in the example scenarios noted above, the following operational scenarios are possible in a time slot:

Some or all of the available transceiver channels can be used to simultaneously communicate (transmit to deliver data and receive the data) between a master node and multiple end nodes.

Some or all of the available transceiver channels can be used to simultaneously communicate (transmit and receive data to be routed in either direction)between one master node and other master nodes.

The number of transceiver channels to be used for communication during a time slot with end nodes generally depends on the number of end devices to which a slot is allocated.

The number of transceiver channels to be used for routing to other master nodes generally depends on the number of free (currently unused) channels, number of messages waiting to be forwarded and number of messages to be received. For example, in a scenario wherein one master node operating as a router needs to communicate with another master node, the router master node may determine the number of free channels currently available, as also the number of messages to be forwarded/received. Based on such considerations/determination, the router master node may use more or fewer transceiver channels for simultaneous transmission/reception or a combination of transmission and reception.

Slot allocation among the end devices will depend on the bandwidth requirement of the end device.

Slot allocation among the router devices is done in such a way that messages to be routed are not delayed beyond acceptable limits, so that end-to-end latency (delay) is within tolerable limits.

Number of channels supported by broadband transceiver at master nodes is designed considering total throughput needed on the network. On a high bandwidth demanding network, a larger number of channels need to be supported by master node transceiver allowing more simultaneous communications and higher throughput.

All nodes in the network are time synchronized and efficiently use the FH sequences to minimize collisions.

In an embodiment, end nodes (wireless field devices 190A-190H in FIG. 1) are battery powered devices, and go into a sleep mode (turn off their transceivers) during the slots in which they do not communicate. Each end node turns its transceivers ON at the beginning of its slot, tunes it into a channel according to the FH sequence and phase, and configures the transceiver to either transmit or receive mode depending on the activity (transmit or receive) scheduled for that slot.

In the foregoing description, the various nodes were described as communicating using time division multiple access (TDMA), with a packet between two nodes being transferred in pre-determined time slots. Alternative embodiments may be implemented using other techniques as described next.

### 6. ALTERNATIVE EMBODIMENTS

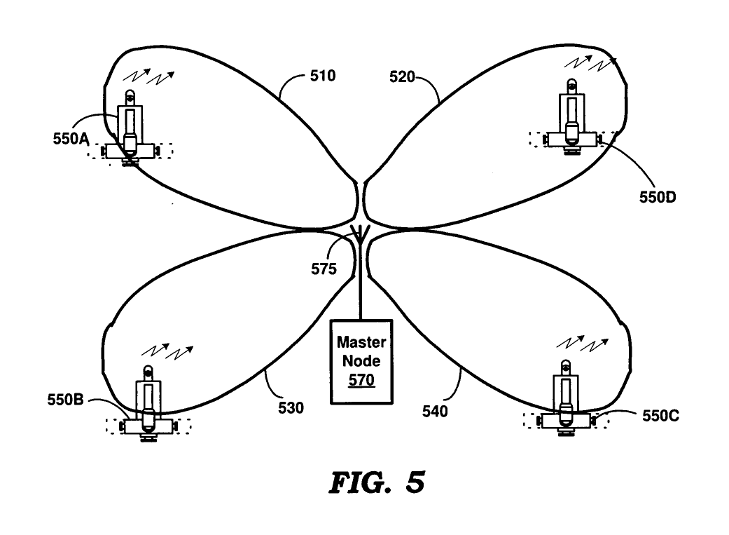

FIG. 5 is a diagram illustrating a portion of a process control system in an alternative embodiment of the present invention, in which space division multiple access (SDMA) technique is used in combination with frequency hopping technique, according to another aspect of the present invention. The diagram is shown containing master node 570, end nodes (wireless field devices) 550A-550D and beam areas (beams) 510/520/530/540. For simplicity, other portions of the process control system are not shown, but it may be understood that other components shown in FIG. 1 can also be present in the process control system.

Master node 570 may be located similar to master 160 of FIG. 1, while end nodes 550A-550D may be located similar to end nodes 190A-190D of FIG. 1. Each of nodes 570 and 550A-550D is provided its own location (geographical co-ordinates) as well as those of the other nodes, in a known way. The co-ordinates can be used to determine the directions in which the antenna gain pattern is to be directed.

When a node needs to transmit packets to another node (master or wireless field device), the node uses digital beam-forming to direct the transmit beam only towards the destination node. In FIG. 5, in master node 570, antenna 575 forms beam 510 when transmitting packets to or receiving packets from end node 550A.

Similarly, master node 570 (or antenna 575) forms beams 520, 530 and 540 respectively when transmitting packets to or receiving packets from end nodes 550D, 550B and 550C respectively. In general, to communicate with multiple neighbors, a node may form multiple beams each carrying communication in a different frequency channel. Digital beam-forming may be performed in a known way.

Though the beam areas are shown non-overlapping, there may be some level of overlap, in which case a corresponding level of interference may be present when the frequency channels in the overlap area are the same. Due to frequency hopping, the possibility of interference is reduced.

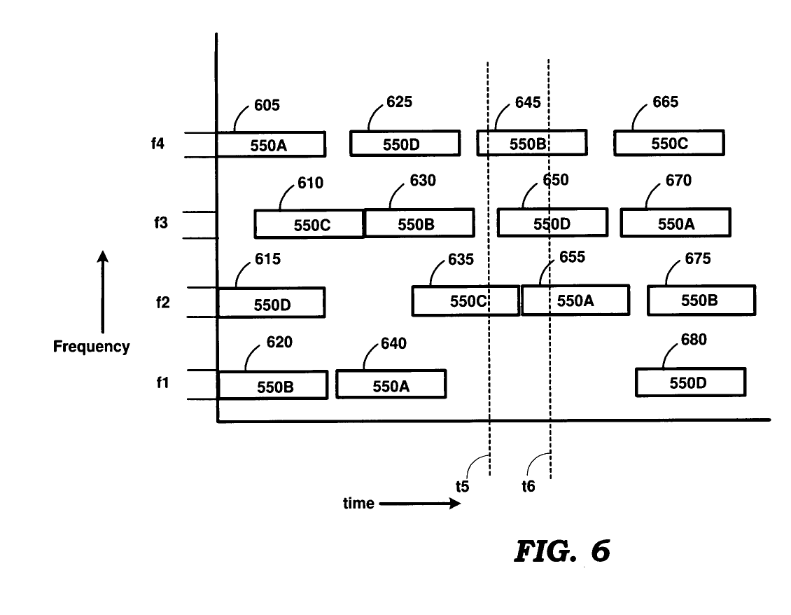

Communication between any two nodes is performed using frequency hopping in a manner described with respect to FIG. 4, except that the time slot boundaries need not be aligned as shown in FIG. 6. The same conventions of FIG. 4 apply in understanding FIG. 6.

As can be readily appreciated from FIG. 6, at time instance t5, packets 645 and 635 are being transmitted in frequency channels f4 and f2 respectively to/from nodes 550B and 550C, and multiple packets are transmitted in a same time duration (e.g., t5-t6). The boundaries of time slots may not be aligned as in the TDMA technique of FIG. 4. However, as may be clearly observed from FIG. 6, transmission durations may overlap as for example, in time duration t5-t6. As a result, communication throughput is enhanced.

Due to the directional beam patterns used in SDMA, the probability of interference in the system is reduced, despite the communication packets being transferred based on time slots which are not aligned across all directions. Further, any new nodes other than those shown in FIG. 5, located outside the communication range (i.e., outside of the four beam areas shown), can use the same frequency currently used by any node in FIG. 5 at the same time. As a result, the possibility of frequency reuse is also enhanced. The specific frequency channels to be used by a node in a time duration may be specified by global scheduler 115, in a manner described above.

In yet another embodiment of a process control system, a combination of TDMA and SDMA techniques noted above is employed. In this embodiment, nodes employ directional beam patterns as illustrated in FIG. 5, but all transmissions are aligned with respect to ‘global’ time slots as in FIG. 4. As with he TDMA embodiment of FIG. 4, global scheduler 115 allocates time slots and frequency channels to the various nodes, in a manner similar to that noted above. The combination of TDMA and SDMA may render the system robust due to interference avoidance. In addition, the system communication throughput is further improved.

Each of the nodes (masters as well as end nodes/wireless field devices) described above may be implemented to contain a transceiver to enable communication as described above. An example implementation of a transceiver is described next.

### 7. TRANSCEIVER

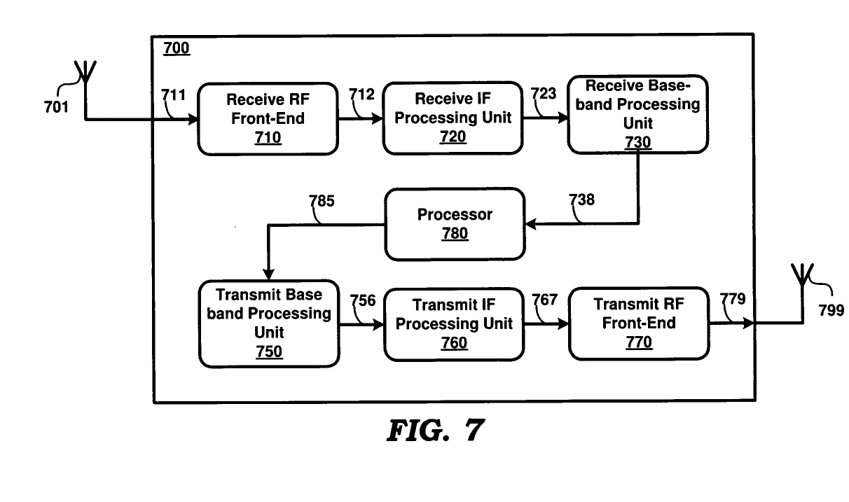

FIG. 7 is a block diagram of a transceiver used in an embodiment of the present invention. Transceiver 700 may be implemented in one or more of the nodes described above, and is shown containing receive antenna 701, receive RF front-end 710, receive IF processing unit 720, receive base-band processing unit 730, transmit base-band processing unit 750, transmit IF processing unit 760, transmit RF front-end 770, transmit antenna 799, and processor 780. For ease of description, transceiver 700 is described below as being implemented in a master node (e.g., master node 160 of FIG. 1). Each component is described below in detail.

Receive antenna 701 (which may be, for example, designed to operate in the 2.4 GHz ISM band ) receives multiple transmitted signals (which may be present in a same duration, as described above), and forwards the (broadband/multiple frequency channel) signal to receive RF front end 710 via path 711.

Receive RF front-end 710 operates to provide functions such as amplification, filtering and down-conversion (analog down-conversion using a mixer) to generate corresponding intermediate frequency (IF) signals. Receive RF front-end 710 also performs analog to digital conversion of the corresponding IF signals, and provides the corresponding digitized IF signals on path 712.

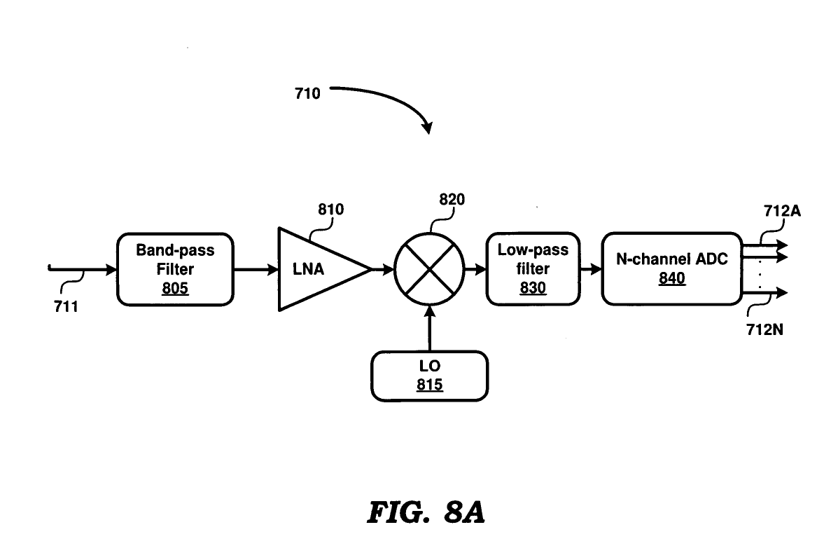

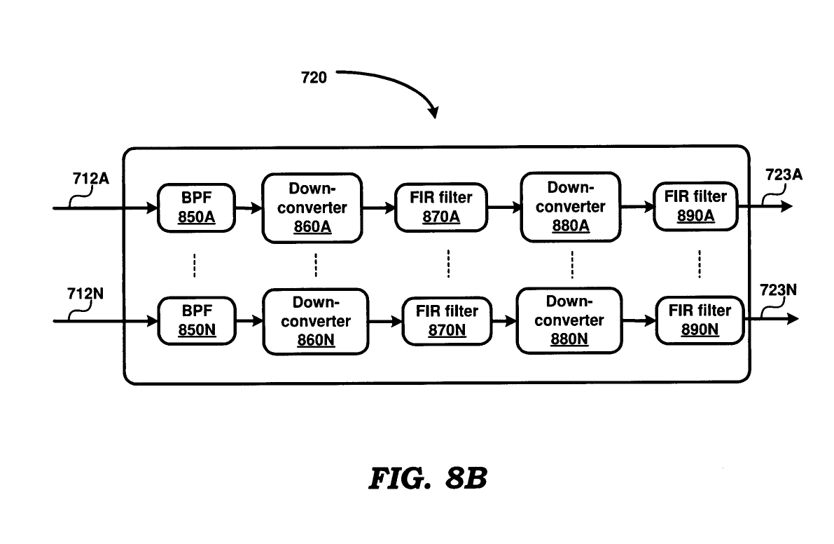

In an embodiment, receive RF front-end 710 is implemented as illustrated in FIG. 8A, wherein paths 712A-712N (N equaling 4 in the illustrative example of FIGS. 4 and 6) are deemed to be contained in path 712 of FIG. 7. The diagram of FIG. 8A is shown containing band-pass filter 805 (passes only the frequencies corresponding to frequency channels of f1-f4), low noise amplifier (LNA) 810 (amplification with low added noise), local oscillator (LO) 815 (generates local signal with a desired frequency), mixer 820 (to down-convert amplified signal by mixing with local signal), low-pass filter 830 (to remove unwanted sidebands generated by mixer 820), N-channel ADC 840 (to provide digital codes corresponding to each of the 4 down converted signals). The desired frequency of the local signal is chosen such that the down-converted signals are at a desired intermediate frequency (IF).

Returning to FIG. 7, receive IF processing unit 720 receives the digitized IF signals on path 712, and performs multi-rate down-conversion and filtering of the IF signals, to convert each of the IF signals to a lower common IF frequency, provided on path 723. In an embodiment, receive IF processing unit 720 is implemented using a field programmable gate array (FPGA with blocks as shown in FIG. 8B, wherein the down-converters (860A/880A, etc,) in an IF signal path together perform the multi-rate down-conversion, and band-pass filters (denoted as BPF 850A etc,) and finite impulse response filters (denoted as FIR filter 870A, 890A, etc.) perform filtering operations. Specifically, filtering using the band-pass filters ensures separation of the multiple signals (in multiple frequency channels). Paths 723A-723N of FIG. 8B are deemed to be contained in path 723 of FIG. 7.

Returning to FIG. 7, receive base-band processing unit 730 receives the corresponding signals, each at the common low IF frequency, and operates to perform demodulation, timing synchronization and data detection to generate data corresponding to each of the multiple transmitted signals. Receive base-band processing unit 730 forwards the corresponding data to processor 780, which may respond to the data in a desired manner (e.g., operate an actuator, or measure a signal via interfaces not shown).

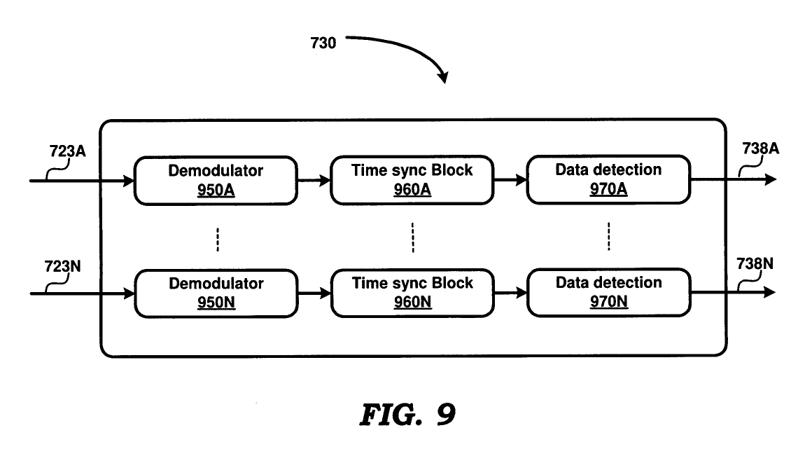

In an embodiment, receive base-band processing unit 730 is implemented as shown in FIG. 9. Demodulators 950A/950N perform data demodulation. Time synchronization blocks 960A-960N operate to determine the best sampling instant to be considered for data detection and also to achieve the symbol synchronization. In general, sampling the symbol at the center of the symbol period (peak) results in the best signal- to-noise ratio and will ideally eliminate intersymbol interference. Data detection blocks 970A-970N take decisions on the sampling instants selected, to determine whether the received signal is a +1 or −1 based on a threshold value in case of NRZ (non-return to zero) data. Processor 780 may then perform preamble detection, synchronization, word detection, payload extraction etc to extract the desired data (since the communication may be bursty in nature), based on the inputs received on path 738.

Returning to FIG. 7, transmit base-band processing unit 750 receives data (to be transmitted to multiple nodes) on path 785, and formats the data into corresponding frames (or packets), and then converts the formatted data into symbol information (I and Q) according to a corresponding modulation scheme. Transmit base-band processing unit 750 may also perform wave shaping of the symbols and modulates a corresponding low frequency carrier with the respective symbols, and provides it on path 756.

Transmit IF processing unit 760 receives the respective low frequency signals on path 756 and operates to up sample (up-convert) the signals using programmable interpolators to generate corresponding signals at IF frequencies. Transmit IF processing unit 760 may subsequently up-convert each of the IF signals to respective (different) frequency channels, adds all the signals in the respective frequency channels, and provides the sum to a digital to analog converter to generate a corresponding analog signal on path 767.

Transmit RF front-end 770 further up-converts (in analog domain) the respective frequency channels to generate the final signals for transmission. The final signals (in separate frequency channels) are provided to antenna 799 for transmission.

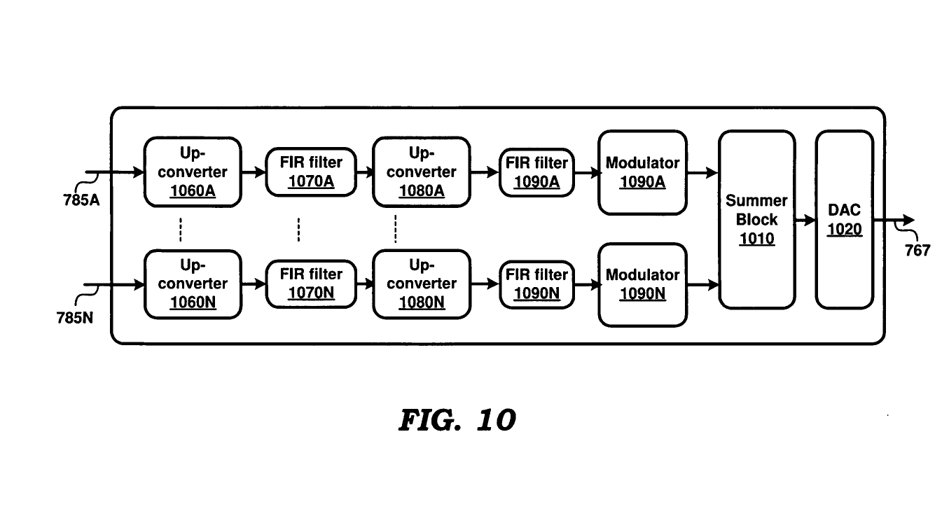

In an embodiment, transmit base-band processing unit 750 and transmit IF processing unit 760 (in combination) are implemented as shown in FIG. 10. Up-converters such as 1060A, 1060N, 1080A, 1080N etc provide the up-conversion operations noted above. FIR filters such as FIR filter 1070A, 1070N, 1090A, 1090N etc provide the filtering operations noted above. Modulators 1090A-1090N operate to modulate corresponding carriers (which may be generated internally) with respective data (I/Q symbols noted above). Summer block 1010 combines the up-converted signals and provides a summed signal to DAC 1020, which generates a combined analog signal on path 767.

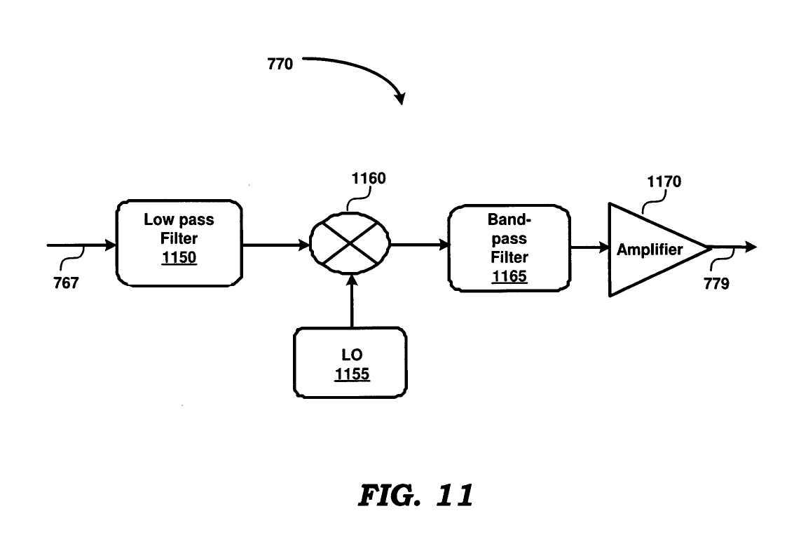

Transmit RF front-end 770 is implemented in an embodiment as shown in FIG. 11, in which the constituent components low-pass filter 1150, mixer 1160, local oscillator 1155, band-pass filter 1165 and amplifier 1170 operate in a known way to generate the final signals in the respective frequency channels on path 779, which are provided to antenna 799 for transmission.

It should be appreciated processor 780 and the other components of FIG. 7 are implemented to enable both transmission as well as reception simultaneously (in parallel or in overlapping time durations).

Thus, using wideband transceivers thus implemented at master nodes (i.e., routers 160/170 and gateway 120 in the example of FIG. 1), the network throughput can be enhanced while using frequency hopping/frequency agile techniques.

In addition, the slave nodes (field devices) can be implemented to support transmission/reception on only a single channel in a time slot, thereby reducing the cost/complexity of the implementation there. It must also be appreciated that, the features described above also improve throughput when a master node communicates with another master node. In such a scenario, each of the master nodes may communicate (transmit, receive, or a combination of transmit and receive) simultaneously on multiple frequency channels in a same (or overlapping) time duration.

It should be further appreciated that the approaches described above can be extended to provide additional benefits. For example, redundant connection paths can be provided for field devices. In an embodiment, multiple routers are configured to receive the same packet transmitted by a single field device based on the frequency agility technique, and the packet is forwarded by all the routers.

With respect to FIG. 1, both master nodes 160 and 170 may be configured with the specific frequencies field device 190C would transmit on in corresponding time slots. Thus, the successive packets transmitted by field device 190C are received and forwarded by each of master nodes 160/170 to the destination indicated by the corresponding packets. Assuming the higher level layers are designed to tolerate duplicate reception of the same content, the duplicate content may be gracefully handled (e.g., discarded).

While the above description is provided with respect to field devices sending packets via the master nodes, it should be appreciated that the same features can be extended to router-to-router communications as well. For example, both master nodes 160 and 170 may be designed to receive/forward data from another master node (not shown) by configuration of the specific frequencies at which the another master node would transmit.

Furthermore, it should be appreciated that the parallel transmissions (i.e., with at least some non-overlapping duration) in corresponding frequency channels can be in any combination of directions. For example, a single device can be receiving such multiple transmissions (from one or more sources), sending such multiple transmissions (to one or more sources), or receiving some of the transmissions and sending some of the transmissions.

### 8. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A process control system comprising:
a plurality of wireless field devices operable to manage equipment in a plant;
a control system to communicate with said plurality of wireless field devices and implement a control strategy in said plant;
a plurality of router nodes to communicate with said plurality of wireless field devices using frequency agility technique, said plurality of router nodes providing communication between said control system and said plurality of wireless field devices,
wherein each of said plurality of wireless field devices and said plurality of router nodes operate as respective ones of a first plurality of nodes communicating using said frequency agility technique,
wherein a first node contained in said first plurality of nodes forms a plurality of packets and transmits the corresponding packet in a corresponding one of a plurality of frequency channels,
wherein said plurality of packets are transmitted in a same duration, and
wherein said plurality of frequency channels are determined by said frequency agility technique.

2. The process control system of claim 1, further comprising:
a wireless gateway through which said control system communicates with said plurality of wireless field devices,
wherein said wireless gateway also communicates with a plurality of master nodes using said frequency agility technique,
wherein a first router node contained in said plurality of router nodes is designed to receive a first packet from said wireless gateway and to route to a first field device contained in said plurality of wireless field devices, and to receive a second packet from said first field device and forward said second packet to said wireless gateway.

3. The process control system of claim 2, wherein said first packet is contained in said plurality of packets in a first time slot and said second packet is contained in said plurality of packets in a second time slot such that said first packet and said second packet are transmitted in different time durations.

4. The process control system of claim 2, wherein said same duration is a time slot such that all of said nodes transmit in said time slot,
wherein all nodes in said process control system are designed to transmit only within time durations defined by a sequence of time slots.

5. The process control system of claim 2, wherein each of said plurality of wireless field devices is located in a corresponding one of a plurality of beam areas, wherein said plurality of beam areas are substantially non-overlapping such that communication between said first router node and said plurality of wireless field devices is space division multiplexed.

6. The process control system of claim 5, wherein transmission to or from each of said plurality of wireless field devices is in a corresponding one of a plurality of time slots, wherein the boundaries of said plurality of time slots are not aligned such that said same duration is only a part of the time slot.

7. The process control system of claim 5, wherein transmission to or from each of said plurality of wireless field devices is in a corresponding one of a plurality of time slots, wherein the boundaries of said plurality of time slots are aligned such that said same duration corresponds to the entire time slot.

8. The process control system of claim 2, wherein said plurality of router nodes further comprises a second router node, wherein said first router node communicates with said second router node on multiple frequency channels determined by said frequency agility technique in said same duration.

9. The process control system of claim 2, wherein said first router node operates as a master node for said first field device and a second field device also contained in said plurality of wireless field devices, wherein each of said first field device and said second field device are designed to communicate only in a single frequency channel in said same duration, wherein each of said first field device and said second field device communicate with said control system only via said first router node.

10. The process control system of claim 2, wherein said first node also receives another packet in said same duration on another channel also determined by said frequency agility technique.

11. The process control system of claim 2, wherein each of a pair of nodes is configured to receive and forward the same packet transmitted by a second node in said same duration on a frequency channel determined by said frequency agility technique, wherein said pair of nodes and said second node are contained in said first plurality of nodes.

12. The process control system of claim 2, wherein said frequency agility technique comprises frequency hopping.

13. A process control system comprising:
a plurality of wireless field devices operable to manage equipment in a plant;
a control system to communicate with said plurality of wireless field devices and implement a control strategy in said plant;
a plurality of router nodes to communicate with said plurality of wireless field devices using frequency agility technique, said plurality of router nodes providing communication between said control system and said plurality of wireless field devices,
wherein each of said plurality of field devices and said plurality of router nodes operate as respective ones of a first plurality of nodes communicating using said frequency agility technique,
wherein a first node contained in said first plurality of nodes transmits a first packet on a first frequency channel and receives a second packet in a second frequency channel,
wherein said first packet and said second packet are transmitted in a same duration, and
wherein said first frequency channel and said second frequency channel are determined by said frequency agility technique.

14. A method of communication between a plurality of field devices and a router in a process control system, said method comprising:
forming a plurality of packets in a first node contained in a plurality of nodes, wherein each of said plurality of nodes is one of said plurality of field devices and said router;
determining a corresponding one of a plurality of frequency channels for each of said plurality of nodes according to a frequency agility technique; and
transmitting each of said plurality of packets from said first node on a corresponding one of said plurality of frequency channels such that multiple packets are transmitted in a same duration.

15. The method of claim 14, wherein said first node is said router and wherein each of said plurality of field devices is implemented to communicate only on a corresponding single channel in any time duration, wherein said single channel is also determined by said frequency agility technique.

16. The method of claim 15, further comprising:
forwarding each of said plurality of packets from a master node to said router,
wherein said forwarding is performed before said transmitting,
wherein both of said master node and said router are implemented to communicate on multiple channels in said same duration, said multiple channels also being determined by said frequency agility technique.

17. The method of claim 16, wherein said frequency agility technique comprises frequency hopping.

18. The method of claim 14, wherein said method further comprises receiving another packet in said first node in said same duration in a corresponding frequency channel determined by said frequency agility technique.
